(19) United States
(12) Patent Application Publication
(10) Pub. No.: US 2010/0033012 A1
(43) Pub. Date: Feb. 11, 2010

(54) Motor Vehicle Controller With Polarity-Reversal Protection

(75) Inventors: Matthias Goecke, Kamakura-shi (JP); Norbert Riegel, Kanagawa (DE); Gerhard Schneider, Sulzbach (DE); Vibhor Singh, Kanagawa (JP)

Correspondence Address: RATNERPRESTIA, P.O. BOX 980, VALLEY FORGE, PA, 19482, US

(73) Assignees: Continental Teves AG & Co. oHG, Frankfurt (DE); Centitemic Miroelectronic GmbH, Nurnberg (DE); Continental Automotive Corporation, Kanagawa (JP)

(21) Appl. No.: 12/519,838

(22) PCT Filed: Dec. 13, 2007
(86) PCT No.: PCT/EP2007/063905

§ 371 Date: Jun. 18, 2009

(30) Foreign Application Priority Data
Jan. 4, 2007 (DE) 102007001624.9

(51) Int. Cl. B60L 1/00

(52) U.S. Cl. 307/9.1

(57) ABSTRACT

For a motor vehicle control device including one or more first high-side-actuated loads which is/are driven by a load actuator and, in particular, at least one further high-side actuated load, wherein the load actuator and the loads are supplied with voltage via at least two high-side paths and via one or more low-side paths connected to a reference potential, a reliable, electronic polarity reversal protection, which ensures a high degree of operational security, is to be made available for a control device, which polarity reversal protection is more cost-effective than existing circuits for polarity reversal protection. For this purpose, at least one active semiconductor component is connected as a polarity reversal protection into a low-side path.

### CROSS REFERENCE TO RELATED APPLICATIONS

This application is the U.S. national phase application of PCT International Application No. PCT/EP2007/063905, filed Dec. 13, 2007, which claims priority to German Patent Application No. DE102007001624.9, filed Jan. 4, 2007, the contents of such applications being incorporated by reference herein.

### BACKGROUND OF THE INVENTION

1. Field of the Invention

The invention relates to a control device, in particular in a motor vehicle on-board power system, comprising one or more first high-side-actuated loads which is/are driven by a load actuation means and, in particular, at least one further high-side actuated load, wherein the load actuation means and the loads are supplied with voltage via at least two high-side paths and via one or more low-side paths connected to a reference potential.

2. Description of the Related Art

In such motor vehicle on-board power systems, various control devices are used, for example as ESP or ABS control devices or else for chassis, the power train or the drive train or else for comfort components, in particular in view of the large number of possible loads or consumers. Such control devices generally have to be protected against damage due to polarity reversal, for example when polarity reversal of just the control device occurs due to workshop errors or else in the event of polarity reversal of the entire on-board power system due to polarity reversal of the battery terminal. For this purpose, a polarity reversal protection for the control devices is usually provided in modern motor vehicle on-board power systems.

Circuits for a polarity reversal protection in electronic devices have been disclosed many times. In the field of motor vehicle control devices, semiconductor diodes, which prevent a flow of current in the direction which is not suitable for the voltage supply, are used to implement a polarity reversal protection, usually in the high-side path of the voltage supply which is at a positive potential. These diodes are frequently costly Schottky diodes.

However, in circuits which are at least partially equipped with discrete components, the configuration and arrangement of the semiconductor diodes plays a possibly considerable role with respect to cost, particularly in the case of mass-produced products. It has become apparent that there is still scope for savings even in circuits which are already carefully constructed according to such criteria.

### SUMMARY OF THE INVENTION

An object of the present invention is then to ensure a reliable, electronic polarity reversal protection, which ensures a high degree of operational security, in a motor vehicle on-board power system of the abovementioned type, in particular with high-side drivers, for a control device, which polarity reversal protection is more cost-effective than existing circuits for polarity reversal protection.

This object is achieved according to aspects of the invention in that at least one active semiconductor component is connected as a polarity reversal protection into a low-side path. The solution according to aspects of the invention therefore consists, in particular, in a new circuit arrangement with low-side polarity reversal protection, which circuit arrangement is a component of a motor vehicle control device. The new circuit arrangement comprises one or more first high-side-actuated loads such as, for example, valve coils, which is/are driven by a load protection means (for example a number of semiconductor drivers), and, in particular, at least one further high-side-actuated load (for example a pump motor, wherein the load actuation means and the loads are supplied with voltage via at least two high-side paths and via a common low-side path which is connected to a reference potential. A particular feature of the circuit is, inter alia, that in the low-side path an active semiconductor component is connected as a polarity reversal protection into the low-side path, that is to say into the ground path of the on-board power system. In this way, it is possible to make available a secure and reliable polarity reversal protection even without complex components such as diodes or the like in the high-side path of the loads.

The circuit arrangement which is described above has, inter alia, the advantage that the costs of the discrete components can be kept particularly low, even if a single circuit is considered. Since the described circuit arrangement is particularly preferably used in control devices in motor vehicle on-board power systems, which control devices are fabricated in very high numbers, there are nevertheless considerable cost advantages. A further advantage is that the circuit has fewer heat losses than a polarity reversal protection with diodes.

An n-type channel field-effect transistor as an active semiconductor component is preferably connected into the ground path as a polarity reversal protection.

A particularly efficient design can be achieved here by arranging the active semiconductor component, which is connected as a polarity reversal protection into the low-side path or ground path of the control device, in such a way that with this component an effective polarity reversal protection can be achieved for a plurality of active components or loads. For this purpose, the active semiconductor component is connected, in a particularly advantageous configuration, into a low-side path or ground path which is common to a plurality of loads. As a result, the semiconductor component which is provided as a polarity reversal protection can replace a plurality of components, in particular diodes, which are otherwise necessary to protect the loads.

At least one further load (for example the already mentioned pump motor) is preferably provided in the circuit arrangement described above, said further load comprising a free-wheeling diode, or a free-wheeling diode in each case, via which the possibly present free-wheeling current of the at least one further load can flow, and in whose ground path the active semiconductor component is connected as a polarity reversal protection. In the free-wheeling path of the further load, there is therefore no longer any need for an active semiconductor component, as a result of which the circuit arrangement can be manufactured even more cost-effectively. In particular, for this reason the free-wheeling diode at the further load is preferably not a Schottky diode.

The high-side actuation of the further load is preferably carried out by means of an active component. As a result, it is possible, for example, to regulate the rotational speed of the motor by means of PWM actuation.

A capacitor is preferably connected between the gate terminal and the source terminal of the active component. Said capacitor provides protection of the comparatively sensitive semiconductor against ESD voltage pulses or negative transient pulses.

The gate actuation of the active component, which provides the polarity reversal protection, is preferably carried out by means of a positive, connected potential, wherein the gate of this component is conductively connected, in particular, to a high-side path circuit for this purpose.

The invention also relates to the use of the abovementioned circuit arrangement in a control device of an electronically controlled brake system, in particular ESP or ABS, or of a passive motor vehicle safety system.

The one or more first loads are preferably inductive loads, in particular valve coils for a hydraulic or pneumatic actuation means.

The at least second load is preferably a motor, in particular a pump motor of a hydraulic or pneumatic assembly.

The advantages achieved with the invention are in particular that by virtue of the connection of an active semiconductor component as a polarity reversal protection for the control devices into the low-side path or ground path of the motor vehicle an effective and operationally reliable polarity reversal protection can be achieved in a particularly simple way and with particularly simple means. In particular when there are a plurality of control devices or loads to be protected, a plurality of components, such as diodes and the like, which are connected the individual voltage-conducting channels or high-side channels can be dispensed with. In this way, in particular the control device of an ESP with a free-wheeling path can be protected in a particularly favorable fashion, wherein the polarity reversal protection diode which is otherwise provided in what is referred to as the Kl30_V path can also be dispensed with, as can the field-effect transistor in the free-wheeling path, wherein in addition the Schottky diode, which otherwise has to be provided there, can be replaced by a comparatively cost-effective SMC diode.

In the case of an ABS system or ESP system with digital or analogue valve actuation without a free-wheeling path, the abovementioned polarity reversal protection can replace the polarity reversal protection diodes which are otherwise provided in what is referred to as the Kl30_V path. In the same way, a comparatively robust pump actuation means with comparatively rapid clocking of the pump can also be implemented, wherein a favorable free-wheeling path can be produced via a suitable diode, which is kept comparatively small.

### BRIEF DESCRIPTION OF THE DRAWINGS

The invention is best understood from the following detailed description when read in connection with the accompanying drawing. Included in the drawing is the following figure:

FIG. 1 is a schematic view of a polarity reversal protection circuit in an electronic brake control device in a motor vehicle on-board power system.

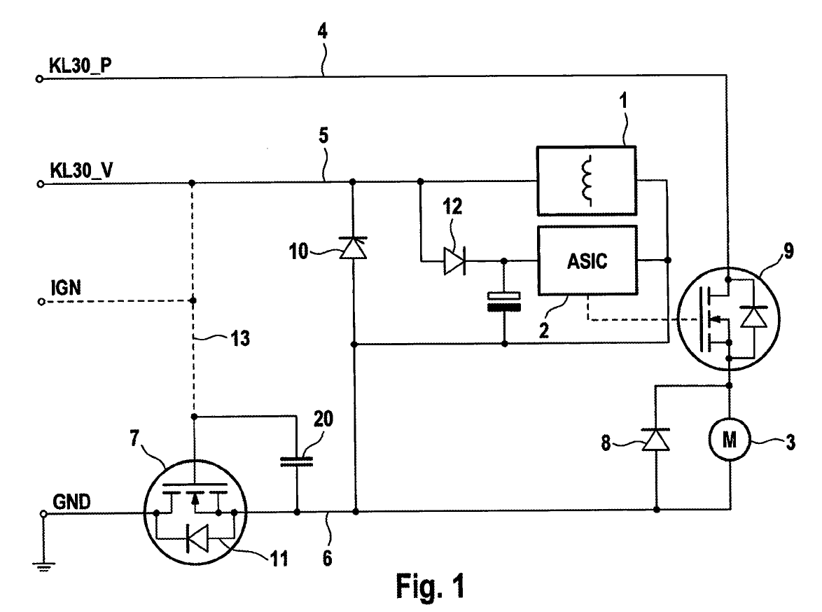

### DETAILED DESCRIPTION OF THE PREFERRED EMBODIMENTS

The control device according to the figure is used in a motor vehicle on-board power system and has a high-side path which is conductively connected via a line 4 to a positive potential (for example positive pole of the vehicle battery). The same applies to the line 5, which is also connected to a positive potential in order to form a further high-side path, also referred to as a Kl30_V path. On the line IGN there is also a positive potential, wherein, in a motor vehicle, said potential can be connected by means of the activation of the ignition.

The line 5 and therefore the high-side path lead to first loads 1 (for example a plurality of valve coils) which are combined by semiconductor drivers, including the actuation logic, in an application-specific circuit (ASIC) 2. Furthermore, the line 5 leads via a diode 12 to the input for the voltage supply of the circuit 2. The ground terminals of the loads 1 and of the circuit 2 are combined and connected to a ground line 6, which provides a connection to a reference potential (ground). In contrast, the line 4 which is connected to the positive potential leads to a high-side driver 9 whose gate is actuated by the circuit 2. The driver 9 actuates a further load 3, in the exemplary embodiment specifically the pump motor of a pressure control assembly. The further load 3 is also connected to the ground line 6.

The control device which is represented by the circuit arrangement has a polarity reversal protection which is kept particularly simple and is accordingly particularly operationally reliable and by means of which the control devices are effectively protected against polarity reversal as a result of workshop errors or incorrect connection of the battery. An active semiconductor component 7, in the exemplary embodiment an n-type channel FET, is connected here into the ground line 6, and therefore into the low-side path or ground path of the on-board power system, as a common polarity reversal protection for the abovementioned loads 1, 3.

If a positive potential is applied due to polarity reversal at terminal GND with respect to line 4 or 5, a negative potential acts via the line 13 on the gate of the semiconductor component 7, which in this case switches off. During normal operation (no polarity reversal) the potential on the line 13 is, in contrast, positive and the semiconductor switch 7 is switched on.

The semiconductor switch 7 comprises an intrinsic diode 11 via which, if the gate actuation means fails, a current can advantageously flow so that the circuit remains operational. The diode 10 produces a conductive connection between a gate of the semiconductor 7 (assigned to the load 3) and the high-side path 5.

In order to protect against negative transient pulses, a capacitor 20 is connected between the gate terminal and the service terminal of the semiconductor component 7.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-8. (canceled)

9. A motor vehicle control device comprising:
one or more first high-side-actuated loads which is/are driven by a load actuation means; and
at least one further high-side actuated load, wherein the load actuation means and the high-side actuated loads are supplied with voltage via at least two high-side paths and via one or more low-side paths connected to a reference potential,
wherein at least one active semiconductor component is connected as a polarity reversal protection into a low-side path.

10. The motor vehicle control device as claimed in claim 9, wherein the active semiconductor component is connected into a low-side path which is assigned to a plurality of loads.

11. The motor vehicle control device as claimed in claim 9, wherein an n-type channel field-effect transistor is provided as an active semiconductor component.

12. The motor vehicle control device as claimed in claim 9, wherein the further high-side-actuated load comprises a free-wheeling diode via which a possibly present free-wheeling current of the at least one further load flows.

13. The motor vehicle control device as claimed in claim 12, wherein the free-wheeling diode at the further load is not a Schottky diode.

14. The motor vehicle control device as claimed in claim 9, wherein high-side actuation of the further load is carried out by an active component.

15. The motor vehicle control device as claimed in claim 9, wherein a capacitor is connected between a gate terminal and a source terminal of the active semiconductor component.

16. The motor vehicle control device as claimed in claim 9, wherein gate actuation of the active semiconductor component is carried out by a positive, connected potential, wherein the gate of the active semiconductor component is conductively connected to at least one of the high-side paths for this purpose.
